(19) United States
(12) Patent Application Publication
(10) Pub. No.: US 2004/0021931 A1
(43) Pub. Date: Feb. 5, 2004

(54) Article including an optical gain equalizer

(76) Inventor: Stuart T. Stanton, Bridgewater, NJ (US)

Correspondence Address: HARNESS, DICKEY & PIERCE, P.L.C., P.O. BOX 8910, Reston, VA, 20195, US

(21) Appl. No.: 10/207,813

(22) Filed: Jul. 31, 2002

(51) Int. Cl. H01S 3/00

(52) U.S. Cl. 359/341.41

(57) ABSTRACT

The optical gain equalizer includes a plurality of active elements. The plurality of active elements are arrayed such that a physical gap between adjacent active elements is distributed in spectral space for a beam incident on the equalizer.

### BACKGROUND OF THE INVENTION

1. Field of the Invention

The present invention relates to gain equalizers used in optical systems; particularly, wavelength division multiplexing systems.

2. Description of Related Art

A wavelength division multiplexed (WDM) transmission link often includes multiple segments of transmission fiber separated by one or more optical amplifiers and other fiber optic components. Generally speaking, it is desirable that these links exhibit uniform signal transmission for all wavelengths. Unfortunately, however, non-uniformity in gain and loss accumulate and eventually cause transmission error unless the signal is equalized.

This equalization is generally accomplished using a dynamic gain equalizer filter (DGEF) such as disclosed in U.S. Pat. No. 5,933,270 and illustrated in part in FIG. 1. In the (DGEF), a grating 14 breaks a WDM signal, from a fiber 10 that passes through a condenser lens 12, into respective wavelength components. The wavelength components pass through the condenser lens 12 and are incident on an equalizer 16. The equalizer 16 acts on the intensity of the individual wavelengths to equalize their intensity. One prior art embodiment of the equalizer 16 performs the intensity adjustment with Fabry-Perot (F-P) etalons, which are essentially chambers having upper and lower mirrors with a gap between them. Depending on the size of the gap, light of a particular wavelength will be reflected back to the fiber 10 via a circulator (not shown for clarity), and other wavelengths will pass through. Another approach involves the use of MEMS mirrors wherein electrodes control the tilt of a mirror to affect the amount of light reflected back for optimal entry into the fiber 10.

Whether using F-P etalons or MEMS mirrors, two prior art embodiments of these systems currently exist: discrete and continuous. FIGS. 2A-2B illustrates simplified version of a discrete MEMS mirror equalizer in which the electrodes, etc. have not been shown for the sake of clarity. As shown, a plurality of mirrors 20 are arrayed along a substrate 18 such that a substantial portion of each mirror 20 is disposed over a gap 21. When a voltage is applied to an electrode (not shown) on the mirror 20, the mirror 20 tilts. FIGS. 3A and 3B illustrates a simplified continuous MEMS mirror equalizer. As shown, a continuous mirror 24 (also referred to as a membrane) is attached at edge portions of the substrate 18 such that the mirror 24 is disposed over the gap 21. Electrodes (not shown) are disposed along the edges of the mirror, which are attached to the substrate 18. When a voltage is applied to an electrode, a portion of the mirror moves.

U.S. Pat. No. 5,943,158 illustrates and describes a discrete F-P etalon equalizer with respect to FIG. 3 thereof, and further illustrates and describes a continuous F-P etalon equalizer with respect to FIGS. 4A-15 thereof. Also see U.S. Pat. No. 5,628,917 and U.S. application Ser. No. 09/536,344 for examples of F-P etalon equalizers.

In a discrete equalizer, an array of mirrors (e.g., mirrors 20 in FIG. 2A) are established such that individual wavelengths from the WDM signal impact distinct mirrors or etalons. As shown in FIG. 2A, beam spots 22 incident on the mirrors 20 will encounter gaps between the mirrors 20 resulting in a discrete spectral response such as shown in FIG. 4. A more continuous spectral response is achieved using the continuous membrane/mirror approach (e.g., membrane 24 in FIG. 3A), but moving the membrane to affect one wavelength tends to affect other wavelengths as well.

### SUMMARY OF THE INVENTION

The equalizer in the article including an optical gain equalizer according to the present invention employs discrete active elements, but provides a continuous spectral response. Namely, a plurality of active elements are arrayed such that a physical gap between adjacent active elements is distributed in spectral space for a beam incident on the equalizer.

In one embodiment, a plurality of active elements are arrayed along a first direction, and a longitudinal axis of each active element is non-perpendicular to the first direction.

In another embodiment, a plurality of first active elements are arrayed along a first direction and a plurality of second active elements are arrayed along the first direction such that portions of the second active elements interdigitate with portions of the first active elements and distribute the physical gaps therebetween in spectral space.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a dynamic gain equalizer filter according to the prior art;

FIGS. 2A-2B illustrates simplified version of a discrete MEMS mirror equalizer according to the prior art;

FIGS. 3A-3B illustrates a simplified continuous version of a MEMS mirror equalizer according to the prior art;

FIG. 4 shows the spectral response of the equalizer illustrated in FIG. 2;

FIGS. 5-6 illustrate one embodiment of an equalizer in a dynamic gain equalizer filter (DGEF) according to the present invention;

FIG. 7 illustrates another embodiment of an equalizer in a dynamic gain equalizer filter (DGEF) according to the present invention;

FIGS. 8 and 9 illustrates further embodiments of an equalizer in a dynamic gain equalizer filter (DGEF) according to the present invention; and

FIGS. 10 and 11 show the spectral response of the equalizer illustrated in FIG. 8.

### DETAILED DESCRIPTION OF EMBODIMENTS

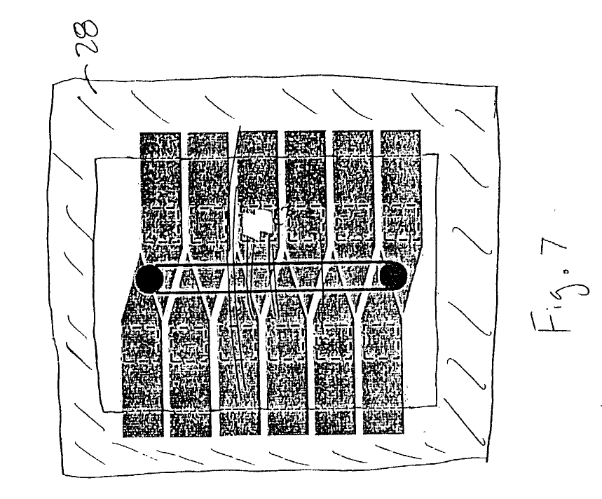

FIGS. 5-6 illustrate one embodiment of an equalizer in a dynamic gain equalizer filter (DGEF) according to the present invention. The equalizer of FIGS. 5-6, as well as the equalizers in the other embodiments described below, are intended to represent a Fabry-Perot etalon based equalizer, a MEMS mirror based equalizer or another active-element (e.g., liquid crystal) based equalizer, but for the purposes of description only have been illustrated in detail as MEMS mirror based equalizers. However, the other active-element embodiments (e.g., F-P etalon and liquid crystal) will be readily apparent from the illustrated embodiment and related detailed description. Because, based on at least the prior art cited above in the Background, the fabrication of the equalizers according to embodiments of the present invention will be readily apparent, the step-by-step fabrication process has not been repeated for the sake of brevity. In addition, besides the prior art methodologies cited in the Background, any of the embodiments of the present invention can be obtained by using the well-known MUMPS process described in detail at http://www.memsrus.com/cronos/svcsmumps.html.

As shown in FIGS. 5-6, the equalizer includes an array of first mirrors 30 having a first section 32 attached to a substrate 28, and a second section 34 suspended over the substrate 28 such that a gap 36 exists between the second section 34 and the substrate 28. The second section 34 includes an extension portion 40 extending from the substrate 28 and an interdigitating portion 42, which will be discussed in more detail below. As shown in FIG. 5, the interdigitating portion 42 has a smaller width in the direction in which the first mirrors 30 are arrayed than the extension portion 40.

As further shown in FIGS. 5-6, the equalizer includes an array of second mirrors 50 arrayed in a same direction as the array of first mirrors 30. The second mirrors 50 have a third section 52 attached to the substrate 28, and a fourth section 54 suspended over the substrate 28 such that the gap 36 exists between the fourth section 54 and the substrate 28. The fourth section 54 includes and second extension portion 60 and a second interdigitating portion 62. As shown in FIG. 5, the second interdigitating portion 62 has a smaller width in the direction in which the second mirrors 50 are arrayed than the second extension portion 60. Additionally, the second interdigitating portions 62 interdigitate with the first interdigitating portion 42. As such, the gaps between interdigitating first and second interdigitating portions 42 and 62 are offset from the gaps between adjacent first extension portions 40, one of which is connected to the first interdigitating portion 42, and second extension portions 60, one of which is connected to the second interdigitating portion 62.

A first electrode 70 is disposed under the end of each first extension section 40 nearest the associated first interdigitating portion 42. Similarly, a second electrode 72 is disposed under the end of each second extension section 60 nearest the associated second interdigitating portion 62. The leads to the first and second electrodes 70 and 72 have not been shown for the sake of clarity, but it will be understood from this description that leads to the first and second electrodes 70 and 72 are provided so that a voltage can be selectively applied to the first and second electrodes 70 and 72. By applying voltages to a first electrode 70, the corresponding first mirror 30 moves, and by applying a voltage to a second electrode 72, the corresponding second mirror 50 moves. Tilting the first and second mirrors 30 and 50 in this fashion affects the amount of light reflected back for optimal entry into the fiber 10, and allows for equalizing the intensity of the respective wavelengths in the WDM signal.

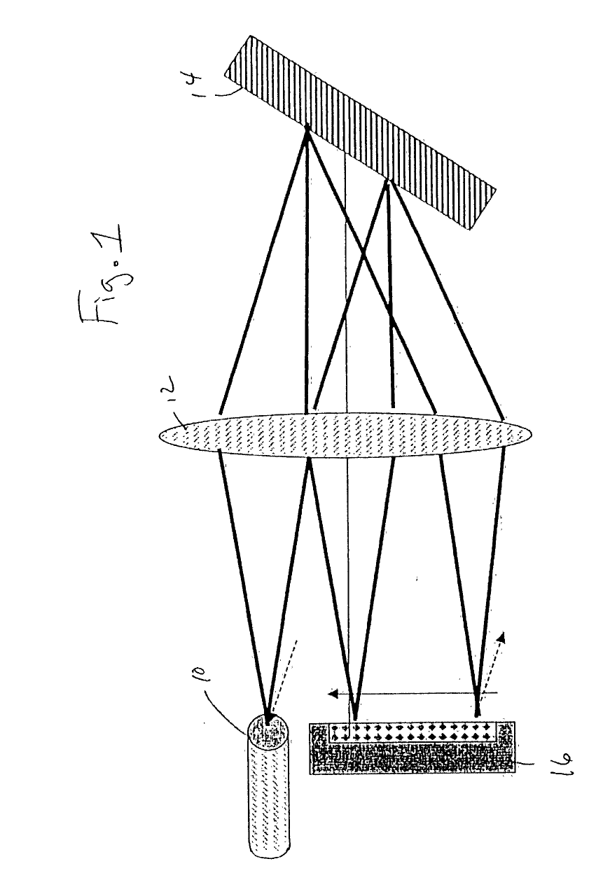

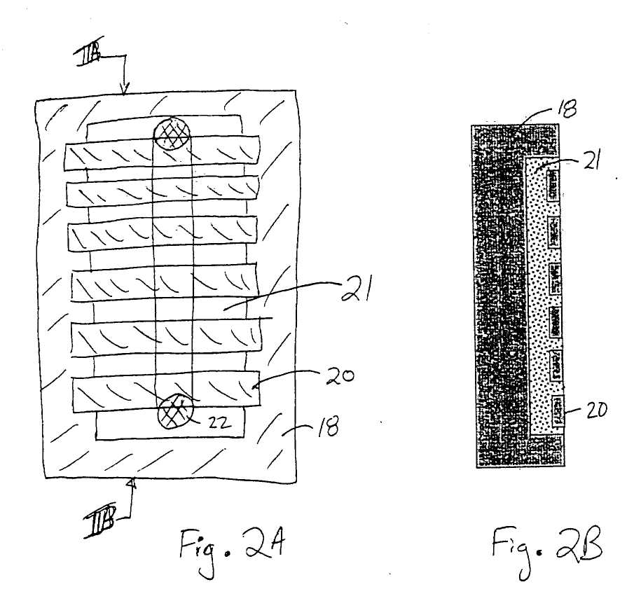

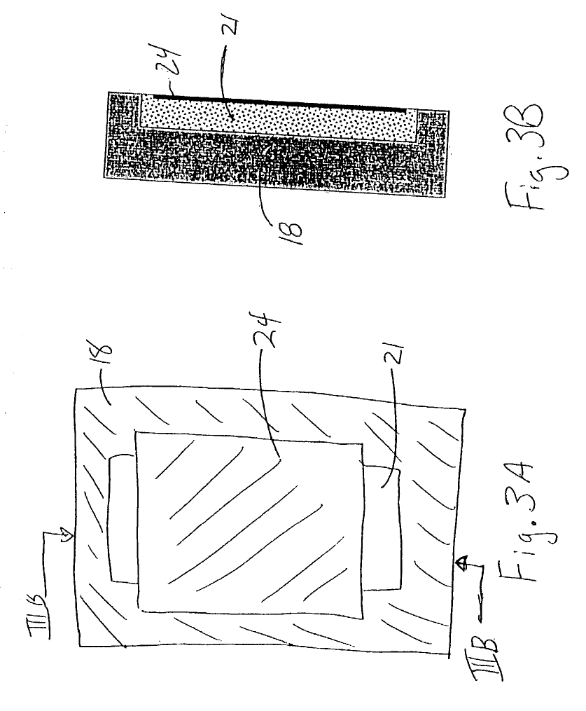

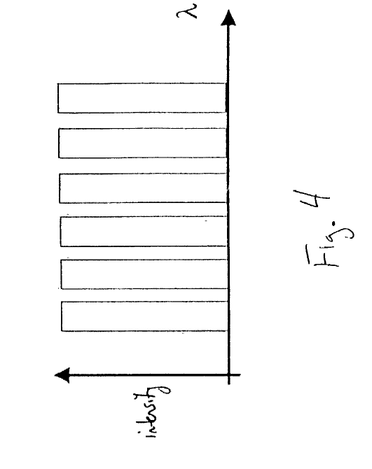

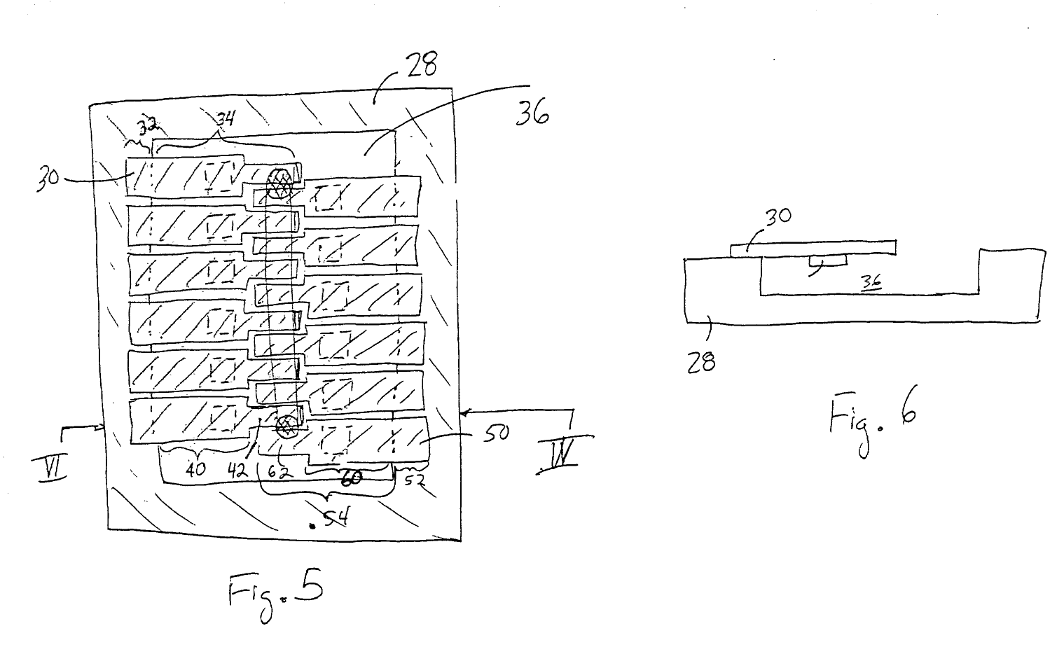

The extension section 40 of each first mirror 30 and the extension section 60 of each second mirror 50 is disposed in alignment with a respective one of the wavelength components separated from the WDM signal by the grating 14 (see FIG. 1). FIG. 5 shows the beam spots of the respective wavelength components incident on the first and second interdigitating portions 42 and 62. As shown, the beam spot diameter is smaller than or equal to the width of first extension section 40 and the second extension section 60. However, because of the first and second interdigitating portions 42 and 62 interdigitate with one another and create gaps there between offset from the gaps between the extension portions 40 and 60, each wavelength component is incident on the first interdigitating portion 42 of at least one first mirror 30 and the second interdigitating portion 62 of at least one second mirror 50. Namely, a substantial portion of the spot energy of a particular wavelength component is distributed over more than one mirror 30 and 50 even though the spot size remains equal to or less than a single one of the mirrors 30 and 50. Consequently, movement of one of the first or second mirror 30 or 50 affects not only the wavelength component associated with that mirror, but adjacent wavelength components as well. And, the equalizer according to the present invention achieves a relatively continuous spectral response by using discrete mirrors or etalons.

The interdigitated mirrors provide one means to distribute the physical gap between the mirrors in spectral space. Those skilled in the art will recognize that a continuous spectral response could be obtained with the conventional discrete equalizer by simply making the spot size large relative to the width of the mirror or etalon (i.e., a beam spot diameter greater than the width of the mirror or etalon) so that the physical gap between mirrors or etalons is blurry or unresolved in the spectrum. However, doing so may result in some kind of spectral dip, and makes it difficult to precisely control the tradeoff between spectral smoothness and shape controllability. By contrast, the equalizer according to the present invention achieves a smooth continuous spectral response, but still permits precise and selective control over each wavelength component. Furthermore, an optical system intended for channelized equalization and providing a small spot can be re-used for continuous equalization by simply introducing a chip with appropriate distribution of the gap between discrete mirrors. The gap is then not resolvable by the optical system and does not appear in the spectral response. The prior description of small interdigitated mirror elements, as compared to the spot size, is one example of distribution of the gap. More sophisticated methods involving more general mirror shape change, described below, are also useful to achieve this result.

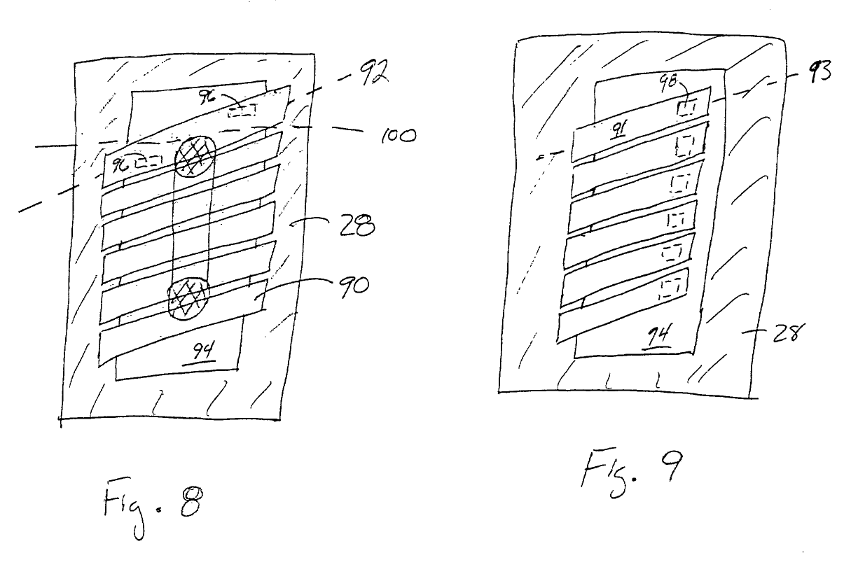

FIG. 7 illustrates another embodiment of the present invention. This embodiment is substantially the same as the embodiment of FIG. 5 except for the shape of the interdigitating portions. Accordingly, only the differences between the two embodiments will be described for the sake of brevity, and like reference numerals designate like elements. As shown in FIG. 7, the first and second interdigitating portions 80 and 82 have a triangular shape. This creates slanting physical gaps between interdigitating first and second interdigitating portions 80 and 82 such that the physical gap between mirrors is again distributed in spectral space. As with the embodiment of FIG. 5, a substantial amount of the spot energy for a particular wavelength component is incident on more than one mirror even though the spot size is equal to or less than the size of an individual mirror or etalon, and movement of a mirror affects more than one wavelength component. As such, the embodiment of FIG. 7 has the same benefits and advantages discussed above with respect to the embodiment of FIGS. 5-6. In addition, the use of slanted or other general shape changes results in distribution of the gap between blades over a finite range associated with the dispersed spectrum, so very smooth spectral response is possible regardless of the spot size.

It should be understood that while two specific embodiments of interdigitating mirrors have described in detail above, numerous differently shaped interdigitating mirror and etalon embodiments are possible, and are intended to be covered within the spirit and scope of the present invention. One skilled in the art would realize that spectral response smoothness and resolution can be tuned by varying the shape and size of mirrors relative to the spot size.

FIG. 8 illustrates another embodiment of the present invention. As shown, a plurality of mirrors 90 are arrayed in a first direction on a substrate 28 over a gap 94. Both ends of each mirror 90 are disposed on the substrate 28 to suspend the mirror 90 over the gap 94. The longitudinal axes 92 of the mirrors 90 are substantially parallel to one another, and non-perpendicular to the first direction. More specifically, the longitudinal axes 92 of the mirrors 90 are on a slant with respect to the first direction. As a result, the spot energy of a wavelength component will be distributed across more than one mirror 90 such that a substantial amount of the energy (i.e., the light) is incident on each those mirrors 90. And, as a result of the slanted physical gap between the mirrors 90, this physical gap is distributed in spectral space. This acheives the same result as slanting in the interdigitated mirror case, but may be an easier chip design to manufacture. Accordingly, tilting one mirror 90 affects more than one wavelength component. The amount of the slant determines the amount of the distribution. As will be appreciated, the equalizer designer will establish the slant based on the desired amount of distribution. Namely, the degree of slant and the shape of the gap between the active-elements are degrees of freedom in the design.

At least two electrodes 96 are positioned substantially on opposite sides of the longitudinal axis 92 of each mirror 90 and at opposite ends of the mirror 90. Applying appropriate voltages to the electrodes 96 cause the mirror 90 to tilt (more specifically, rotate or twist in this embodiment) about an axis of torsion 100.

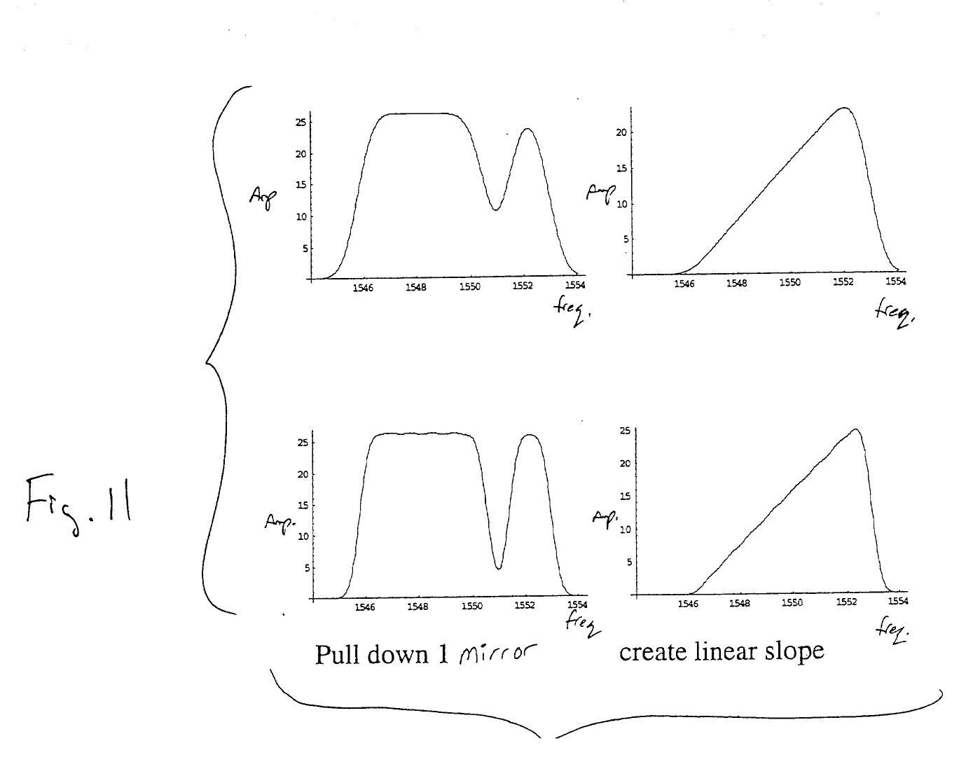

FIGS. 10 and 11 illustrate the spectral response of an example of the embodiment described above with respect to FIG. 8. The example included mirrors 90 having a width of 27 microns. The top two graphs show the spectral response for mirrors slanted at 50% slope, and the bottom two graphs show the spectral response when the mirrors 90 have no slant. A 50 mm focal length lens and 600 l/mm grating @ Littrow condition were used to generate a spot size of 10 microns FW@1/e\hat{ }2 in FIGS. 10 and 20 microns FW@1/e\hat{ }2 in FIG. 11. The graphs on the left of FIGS. 10 and 11 illustrate the effects of a 1 mirror pull down and the graphs on the right illustrate linear loss versus wavelength response spectrum.

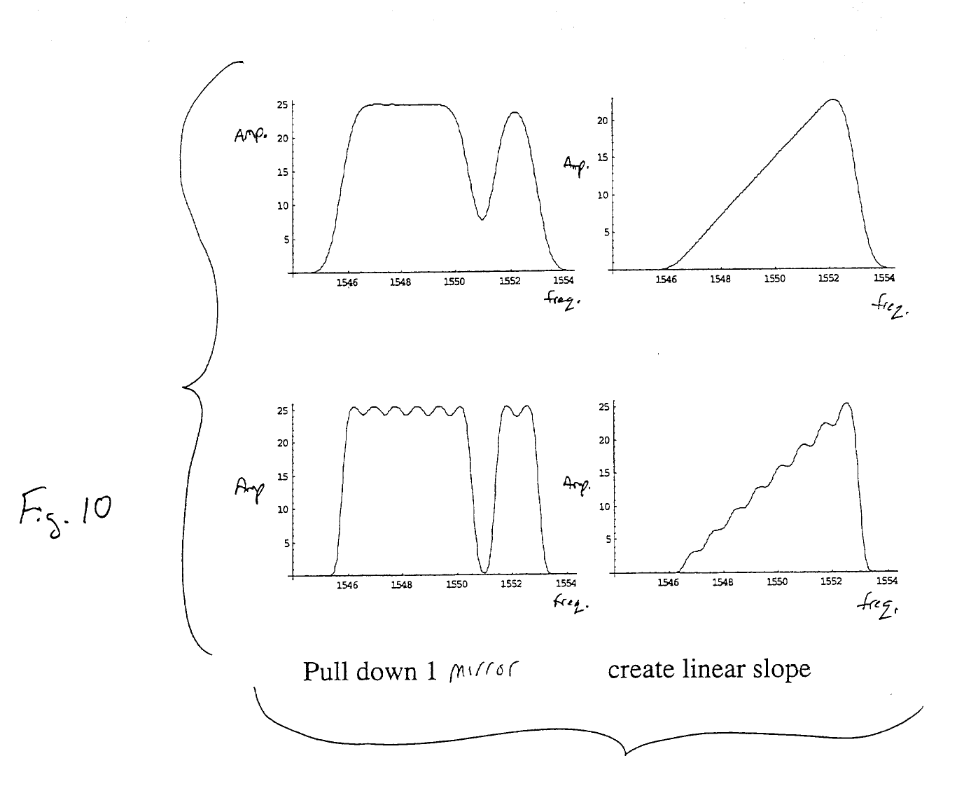

FIGS. 9 illustrates a further embodiment of the present invention in a different mirror-tilting configuration. As shown, a plurality of mirrors 91 are arrayed in a first direction on a substrate 28 over a gap 94. A single end of each mirror 91 is on the substrate 28 to suspend the mirror 91 over the substrate 28. The longitudinal axes 93 of the mirrors 91 are substantially parallel to one another, and non-perpendicular to the first direction. More specifically, the longitudinal axes 93 of the mirrors 91 are on a slant with respect to the first direction. As a result, the spot energy of a wavelength component will be distributed across more than one mirror 91 such that a substantial amount of the energy (i.e., the light) is incident on each those mirrors 90. And, as a result of the slanted physical gap between the mirrors 91, this physical gap is distributed in spectral space. The amount of the slant determines the amount of the distribution. As will be appreciated, the equalizer designer will establish the slant based on the desired amount of distribution. Accordingly, tilting one mirror 91 affects more than one wavelength component. In the embodiment of FIG. 9, an electrode 98 is disposed nearer the distal end than the proximal end of each mirror 91. Applying an appropriate voltage to the electrode 98 causes the mirror 91 to tilt (in this case flex) relative to the substrate 28. In the embodiments of FIGS. 8 and 9, even though the tilting movement of the mirror is different, the same result is achieved; namely, tilting a mirror 90 or 91 affects the amount of light reflected back for optimal entry into the fiber 10.

The invention being thus described, it will be obvious that the same may be varied in many ways. For example, while the embodiments have been described above with respect to MEMS mirror implementations, the present invention including the specifically described embodiments are equally applicable to F-P etalons and other active-element (e.g., liquid crystal based equalizers). In addition, the use of slanted mirror features and distribution of the gap between discrete mirror elements may be associated with the use of anamorphic optical elements such as disclosed in concurrently filed application no. unknown, entitled AN OPTICAL DEMULTIPLEXER/MULTIPLEXER ARCHITECTURE by the inventor of the present invention. This approach may result in changes in the beam shape in the plane of the mirror array, and hence distribution of light on the mirrors as a function of wavelength. This variable interplay between optics anamorphic power and mirror shape may allow tuning the smoothness and resolution of the spectral response using less complex shapes or reduced slant angle. Such variations are not to be regarded as a departure from the spirit and scope of the invention, and all such modifications are intended to be included within the scope of the following claims.

1. An article including an optical gain equalizer, comprising:
a plurality of active elements arrayed along a first direction, and a longitudinal axis of each active element being non-perpendicular to the first direction.

2. The article of claim 1, wherein the active elements are moveable, and further comprising:
tilt means associated with each movable active element for tilting the associated movable active element about the longitudinal axis of the movable active element.

3. The article of claim 1, wherein the longitudinal axes of the active elements are parallel to one another.

4. The article of claim 4, wherein the plurality of active elements are arrayed along the first direction such that a substantial amount of light from a beam spot is incident on more than one active element.

5. The article of claim 1, wherein the active elements are one of Fabry-Perot etalons, mirrors and liquid crystal elements.

6. An article including an optical gain equalizer, comprising:
a plurality of active elements arrayed along a first direction, and a longitudinal axis of each active element being established such that a substantial portion of the beam spot incident on one of the active elements is incident on at least one other of the active elements.

7. The article of claim 6, wherein the longitudinal axis of each active element is non-perpendicular to the first direction.

8. The article of claim 6, wherein the active elements are moveable, and further comprising:
tilt means associated with each movable active element for tilting the associated active element about the longitudinal axis of the movable active element.

9. The article of claim 6, wherein the longitudinal axes of the active elements are parallel to one another.

10. The article of claim 6, wherein the plurality of active elements are arrayed along the first direction such that a substantial amount of light from a beam spot is incident on more than one active element.

11. The article of claim 6, wherein the active elements are one of Fabry-Perot etalons, mirrors and liquid crystal elements.

12. An article including an optical gain equalizer, comprising:
a plurality of first active elements arrayed along a first direction; and
a plurality of second active elements arrayed along the first direction such that portions of the second active elements interdigitate with portions of the first active elements and distribute the physical gaps therebetween in spectral space.

13. The article of claim 12, wherein the first active elements have longitudinal axes perpendicular to the first direction; and
the second active elements have longitudinal axes perpendicular to the first direction.

14. The article of claim 12, wherein
the first active elements have longitudinal axes parallel to one another; and
the second active elements have longitudinal axes parallel to one another.

15. The article of claim 14, wherein the longitudinal axes of the first active elements are parallel to the longitudinal axes of the second active elements.

16. The article of claim 12, wherein
the portions of the first active elements interdigitating with the portions of the second active elements are substantially rectangular; and
the portions of the second active elements interdigitating with the portions of the first active elements are substantially rectangular.

17. The article of claim 12, wherein
the portions of the first active elements interdigitating with the portions of the second active elements are substantially triangular; and
the portions of the second active elements interdigitating with the portions of the first active elements are substantially triangular.

18. The article of claim 12, wherein the active elements are moveable, and further comprising:
moving means for moving the first and second active elements.

19. The article of claim 12, wherein the active elements are one of Fabry-Perot etalons, mirrors and liquid crystal elements.

20. An article including an optical gain equalizer, comprising:
a plurality of first active elements arrayed along a first direction; and
a plurality of second active elements arrayed along the first direction such that a beam incident on one of the first active elements is incident on one of the second active elements.

21. The article of claim 20, wherein portions of the second active elements interdigitate with portions of the first active elements.

22. The article of claim 20, wherein the active elements are one of Fabry-Perot etalons, mirrors and liquid crystal elements.

23. An article including an optical gain equalizer, comprising:
a plurality of active elements arrayed such that substantial amount of light from a beam spot is incident on more than one active element.

24. The article of claim 22, wherein the active elements are one of Fabry-Perot etalons, mirrors and liquid crystal elements.

25. An article including an optical gain equalizer, comprising:
a plurality of active elements arrayed such that a physical gap between adjacent active elements is distributed in spectral space for a beam incident on the equalizer.

26. The article of claim 24, wherein the active elements are arrayed such that a spectral response of a beam spot scanned over the equalizer is substantially continuous.

27. The article of claim 24, wherein the active elements arc one of Fabry-Perot etalons, mirrors and liquid crystal elements.

28. The article of claim 26, wherein the active elements are arrayed in a direction and have parallel longitudinal axis that form a non-perpendicular angle with the arrayed direction.

29. The article of claim 26, wherein the active elements comprise:
a plurality of first active elements arrayed along a direction; and
a plurality of second active elements arrayed along the direction such that portions of the second active elements interdigitate with portions of the first active elements.
